(19) United States
(12) Patent Application Publication
(10) Pub. No.: US 2006/0246246 A1
(43) Pub. Date: Nov. 2, 2006

(54) Process for cutting heat applied indicia

(76) Inventor: Brett A. Stahl, Grosse Pointe Farms, MI (US)

Correspondence Address: Christopher J. Fildes;Fildes & Outland, P.C., Suite 2, 20916 Mack Avenue, Grosse Pointe Woods, MI, 48236, US

(21) Appl. No.: 11/120,221

(22) Filed: May 2, 2005

(51) Int. Cl. B32B 38/04; B26D 3/00; B26D 1/00; B32B 33/00; B41M 5/00; B32B 37/00

(52) U.S. Cl. 428/41.8; 156/250; 156/256; 156/265; 156/268; 83/13; 83/39; 428/195.1

(57) ABSTRACT

A process for cutting indicia adapted to be applied to an object includes providing a flat bed cutter including a cutting head such as a blade, knife, or laser cutter capable of cutting multiple depths relative to a supporting surface; providing a material having an applicable layer and a supporting carrier layer; positioning the material relative to the flat bed cutter; making an indicia cut through the applicable layer of an outline of at least two indicia to be applied side by side on the object; and making a border cut through the applicable layer and the supporting carrier layer beyond the indicia cut to form a polygonal shape.

### TECHNICAL FIELD

This invention relates to heat applied indicia, and more particularly to a process for cutting heat applied indicia to form a material having more than one heat applicable indicia thereon with accurate spacing.

### BACKGROUND OF THE INVENTION

It is known in the art relating to heat applied indicia to provide a single indicia disposed on a carrier layer for transfer by tacking (i.e., heat application) to an article of clothing such as a sports team jersey, t-shirt, sweatshirt, jacket, apron, cap, etc., or to another suitable item capable of receiving the indicia. The indicia may be, for example, a letter, number, or a graphic such as a baseball, football, or similar, and may be made of a thin layer of polymer material. The indicia layer is supported by the carrier layer prior to transfer onto an object. To apply the indicia to an object such as an article of clothing, the indicia layer is placed face down on the object such that the indicia is disposed between the object and the carrier layer. The indicia may then be positioned by moving the indicia and corresponding carrier layer to a desired location on the object. Heat is then applied through the carrier layer, resulting in the indicia becoming fixed on the object. The carrier layer may then be freely removed and discarded, leaving a finished product.

Positioning of the indicia on the object, however, becomes difficult when more than one indicia must be applied to an object such as, for example, a sports jersey. Each indicia must be adjusted separately and must be aligned either by visual adjustment (“eye-balling”) or with the aide of a ruler and/or straight edge. It can be especially difficult to align numbers such as 4's and 7's that lack long peripheral edges that are parallel to the left-right and up-down axes of the number. It is similarly difficult to align certain letters. Further, is it also difficult to align numbering and/or lettering with indicia that are graphics such as baseballs, footballs, etc.

### SUMMARY OF THE INVENTION

The present invention provides a process for cutting indicia that results in the pre-spacing and pre-positioning of letters, numbers, and/or graphics relative to each other. The indicia are cut such that they pre-spaced and pre-positioned on a single sheet of carrier material. This process thereby allows a user to avoid having to tediously adjust and position individual letters, numbers, and graphics relative to each other prior to application. Instead, the user simply adjusts the positioning of the entire letter/number/graphic combination relative to the transfer material by adjusting and aligning the edges of the carrier layer. The corners of the carrier layer may be used as reference points for accurate positioning. In addition, locating means such as notches or the like may be disposed around the carrier layer for positioning the indicia on an object.

More particularly, a process for cutting indicia adapted to be applied to an object includes providing a flat bed cutter. The flat bed cutter includes a cutting head or laser capable of cutting multiple depths relative to a supporting surface. Further, a material is provided having an applicable layer and a supporting carrier layer. The material is positioned relative to the flat bed cutter. An indicia cut is made through the applicable layer of an outline of at least two indicia to be applied side by side on the object. A border cut is made through the applicable layer and the supporting carrier layer beyond the indicia cut to form a polygonal shape.

In one embodiment of the process, the applicable layer may include a thermoplastic or heat transferable fabric. Further, the applicable layer may be a composite film including a thermoplastic polyurethane or PVC and a thermoplastic polyester or PVC adhesive. The carrier layer may be a polyester film or paper release sheet. The polygonal shape of the cut material may be a rectangle or a square. The supporting surface may be a vacuum table.

A material for applying indicia onto an object according to the present invention includes a supporting carrier layer and an applicable layer disposed on the carrier layer. A plurality of separate indicia in the applicable layer are defined by cut lines through the applicable layer. The plurality of indicia are positioned on the carrier layer in a spatial relationship relative to each other corresponding to the spatial relationship the indicia are to have relative to each other when applied to an object. Due to this spatial relationship, the indicia are pre-positioned and pre-aligned relative to each other for easy and accurate application onto an object.

In one embodiment, the material has an outer boundary defining a polygonal shape, wherein the plurality of indicia are disposed within the outer boundary. The polygonal shape may be a rectangle or a square. The material may have a margin adjacent each side of the polygonal shape. Each of the margins is defined between the outer boundary and a cut line of the indicia and opposite margins of the material may be equivalent. The carrier layer may be a polyester film and the applicable layer may include a thermoplastic or heat transferable fabric. Each of the indicia may be chosen from a group consisting of letters, numbers, and graphics.

These and other features and advantages of the invention will be more fully understood from the following detailed description of the invention taken together with the accompanying drawings.

### BRIEF DESCRIPTION OF THE DRAWINGS

In the drawings:

FIG. 1 is an environmental view of a flat bed cutter cutting a material in accordance with the present invention;

FIG. 2 is a plan view the material of FIG. 1 illustrating indicia and border cuts made by the cutter;

FIG. 3 is a side cross-sectional view of the material taken along the line 3-3 in FIG. 2;

FIG. 4 is a plan view of a material for applying indicia onto an object according to the present invention; and

FIG. 5 is a side view of the material of FIG. 4.

### DETAILED DESCRIPTION OF THE INVENTION

Referring now to the drawings in detail, numeral 10 generally indicates a cutting apparatus such as a flat bed cutter or similar for use in a process for cutting indicia adapted to be applied to an object. The cutting process results in the pre-spacing and pre-positioning of letters, numbers, and/or graphics relative to each other on a single sheet of carrier material. This allows a user to easily adjust the positioning of the indicia on the object to which the indicia are to be applied prior to application, thereby eliminating the tedious adjustment of individual letters, numbers, and graphics relative to each other.

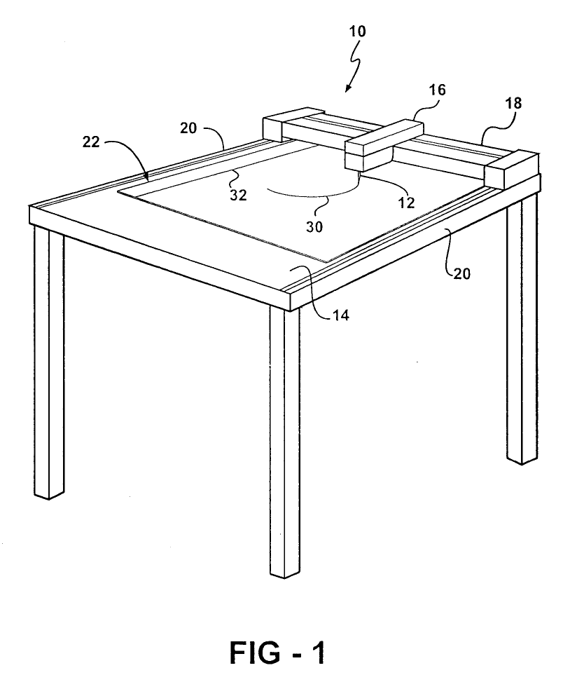

With reference to FIG. 1, the flat bed cutter 10 includes a cutting head 12 including a blade, knife, or laser cutter capable of cutting multiple depths relative to a supporting surface 14. The cutting head 12 may be supported by a carriage 16 that is movable along a guide 18. The guide 18 itself may be movable along opposing edges 20 of the supporting surface 14 via guides (not shown). This allows the cutting head 12 to be oriented and moved in any direction relative to the supporting surface 14. The supporting surface 14 itself may be a vacuum table wherein during use the vacuum draws air from above the supporting surface 14 to an underside of the supporting surface, thereby immobilizing an item placed on top of the supporting surface.

Turning now to FIGS. 1 through 3, in the process according to the present invention, a material 22 having an applicable layer 24 and a supporting carrier layer 26 is used. The applicable layer 24 may include a thermoplastic or heat transferable fabric and may be a composite film including a thermoplastic polyurethane or PVC and a thermoplastic adhesive such as a polyester, polyurethane, PVC adhesive or similar. The applicable layer 24 also typically includes a pigment to give color to the applicable layer. As an example, the applicable layer 24 may be Thermo-FILM®-brand material available from Stahls' Inc., Web Flex®-brand material from R.J. Liebe Co. but other similar materials are acceptable. Suitable heat transferable fabric materials include Poly-TWILL™-brand material available from Stahls' Inc. The specific type of film/material chosen for the applicable layer 24 depends in part on the material of the object that the applicable layer is to be adhered to. The carrier layer 26 may be a polyester film, such as Mylar®-brand polyester film available from DuPont or Magic Mask® available from Stahls', or the carrier layer 26 may be a paper release sheet such as Transel™-brand paper release sheets available from One Step Papers. The carrier layer 26 supports the applicable layer 24 until the applicable layer 24 is applied to an object through the use of heat, as described in more detail below. The material 22 is relatively thin and sheet-like, and may be rolled into a roll for easy transportation, storage, and dispensing during use.

The material 22 is positioned relative to the flat bed cutter 10 (see FIG. 1). More specifically, the material 22 is positioned on the supporting surface 14 such that the material lies flat on the supporting surface and within the edges 20 of the supporting surface. If the supporting surface 14 is a vacuum table, the vacuum (not shown) sucks the material 22 to the surface so that the material is immobilized.

After the material 22 is positioned on the supporting surface 14, the cutting head 12 may be used to make cuts in the material. In the process according to the invention, an outline of at least two indicia 28 to be applied side-by-side on an object are made by indicia cuts 30 through the applicable layer 24. An indicia 28 is herein defined as a single character such as a letter or number, or a single graphic such as a baseball, football, or similar. The indicia cuts 30 are only in the applicable layer 24 and do not penetrate the carrier layer 26, thereby leaving the carrier layer intact adjacent the indicia 28. Based upon the location of the indicia cuts 30, the indicia 28 are pre-positioned and pre-aligned relative to each other.

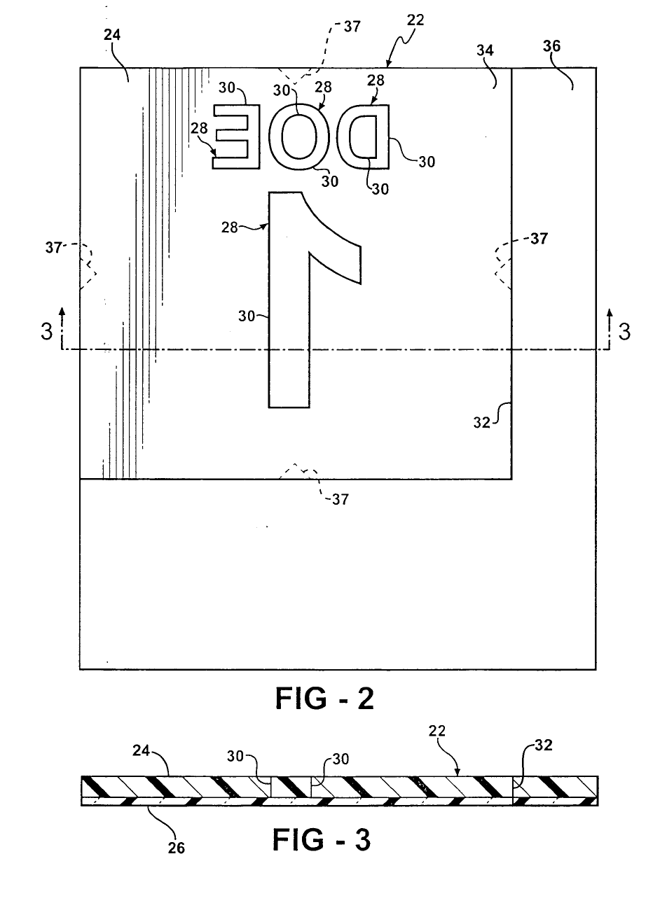

Further, a border cut 32 is made through the applicable layer 24 and the supporting carrier layer 26 beyond the indicia cuts 30 to form a polygonal shape defined by the border cut 32 and the other pre-cut and/or pre-existing edges of the material 22. Therefore, the border cut 32 separates the material 22 into pieces 34, 36. In the example shown in FIG. 2, the border cut 32 defines two sides of the polygonal shape while the other two sides of the polygonal shape are defined by pre-existing edges of the material 22. The polygonal shape is preferably a parallelogram such as a rectangle or a square, as these shapes are the easiest to align on an object for application of the indicia (see below). The polygonal shape, however, may be any other polygon such as a triangle, pentagon, hexagon, etc.

The resulting piece of material 34 may then be used to simply and easily align the indicia 28 on an object for application. The object may be an article of clothing such as a sports team jersey, t-shirt, sweatshirt, jacket, apron, cap, etc. (i.e., objects made of fabric materials), or an article such as a water bottle, hockey puck, lawn sign, or even a window pane. For purposes of example, the object will be hereinafter referred to as a jersey. The area on the jersey where the indicia 28 are to be located is laid flat on a smooth surface. All of the excess applicable layer 24, in other words, the pieces of applicable layer that do not form the indicia 28, are weeded away, (i.e., removed and discarded). The piece of material 34 is placed on the jersey with the applicable layer 24 between the jersey and the carrier layer 26. The indicia 28 are then positioned relative to the jersey simply by adjusting the piece of material 34 and by aligning the edges of the polygonal shape of the piece of material with seams or other distinguishing features of the jersey such as the collar. Alternatively, the outer boundary line may have a notch 37 on sides thereof to indicate, for example, the center line or other reference of the indicia 28 for positioning purposes. Then, generally, heat is applied to the positioned indicia 28 through the carrier layer 26, causing the indicia 28 to adhere to the jersey. The carrier layer 26 is then removed, leaving a jersey with accurately aligned indicia 28.

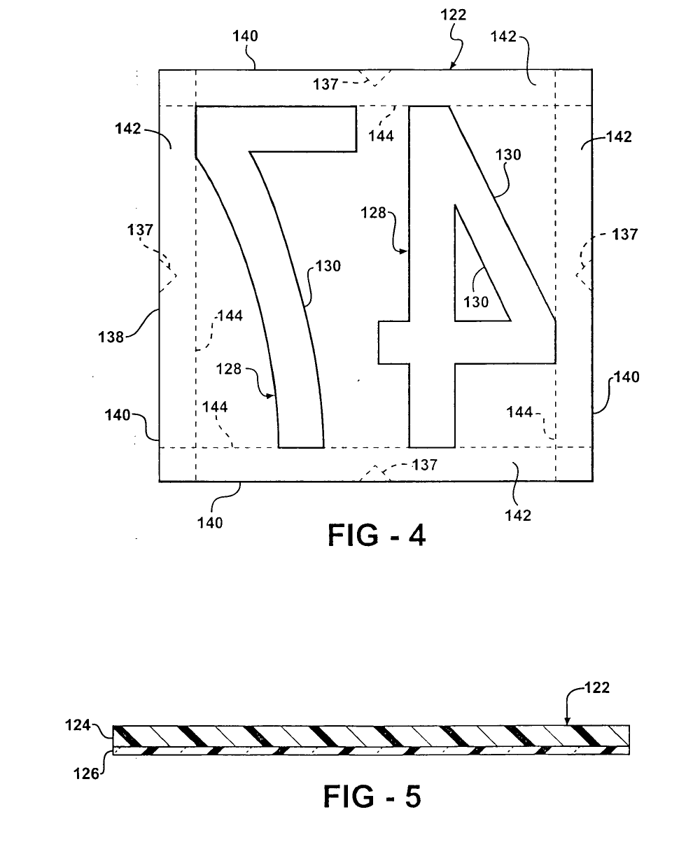

With reference to FIGS. 4 and 5, in an alternative embodiment, a material 122 according to the present invention for applying indicia 128 onto an object includes an applicable layer 124 and a supporting carrier layer 126. The applicable layer 124 is disposed on the carrier layer 126. The applicable layer 124 may include a thermoplastic and the carrier layer 126 may be a polyester film or paper release sheet.

The material further includes a plurality of separate indicia 128 in the applicable layer 124 defined by cut lines 130 through the applicable layer 124. The cut lines 130 do not extend into the carrier layer 126. For purpose of example, in FIG. 4 the indicia 128 are shown as the numbers “4” and “7.” It should be understood, however, that the indicia 128 may also be letters, graphics, symbols, etc. The plurality of indicia 128 are positioned on the carrier layer 126 in a spatial relationship relative to each other corresponding to the spatial relationship the indicia are to have relative to each other when applied to an object (as described above).

In a specific embodiment of the material 122, the material 122 may have an outer boundary 138 defining a polygonal shape having sides 140. The sides 140 themselves define the outer boundary 138. The plurality of indicia 128 are disposed within the outer boundary 138. The polygonal shape is preferably a parallelogram such as a rectangle or square, but may also be any other polygon such as a triangle, pentagon, hexagon, etc.

The material 122 may further have a margin 142 adjacent each side 140 of the polygonal shape. Each of the margins 142 is defined as the space between the outer boundary 138 and a cut line 130 of the indicia 128. The edge of the cut line 130 closest to each side 140 of the polygon defines the inner boundary 144 of each margin 142. More simply, the margins 142 of the material 122 are similar to margins on a document; the margins 142 are the outer portion of the “sheet” of material in which there are no indicia 128 present. In this embodiment, opposite margins 142 of the material 122 may be equivalent in size. This aides in the left-right and up-down alignment of the material 122 on an object to which the indicia 128 are to be adhered because the indicia 128 are then an equal distance from opposing sides 140 of the material 122. optionally, the sides 140 of the material 122 may also include a notch 137 to indicate, for example, the center line or other reference of the indicia 128 for positioning purposes.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A process for cutting indicia adapted to be applied to an object, the process comprising the steps of:
providing a flat bed cutter including a cutting head capable of cutting multiple depths relative to a supporting surface;
providing a material having an applicable layer and a supporting carrier layer;
positioning said material relative to said flat bed cutter;
making an indicia cut through said applicable layer of an outline of at least two indicia to be applied side by side on said object; and
making a border cut through said applicable layer and said supporting carrier layer beyond said indicia cut to form a polygonal shape.

2. A process as in claim 1, wherein said applicable layer includes a thermoplastic.

3. A process as in claim 1, wherein said applicable layer is one of a heat transferable fabric and a composite film including a thermoplastic polyurethane or PVC and a thermoplastic adhesive.

4. A process as in claim 1, wherein said carrier layer is one of a paper release sheet and a polyester film.

5. A process as in claim 1, wherein said polygonal shape is one of a rectangle and square.

6. A process as in claim 1, wherein said supporting surface is a vacuum table.

7. A material for applying indicia onto an object, said material comprising:
a supporting carrier layer;
an applicable layer disposed on said carrier layer; and
a plurality of separate indicia in said applicable layer defined by cut lines through said applicable layer;
wherein said plurality of indicia are positioned on said carrier layer in a spatial relationship relative to each other corresponding to the spatial relationship the indicia are to have relative to each other when applied to an object.

8. The material of claim 7, wherein said material has an outer boundary defining a polygonal shape, said plurality of indicia being disposed within said outer boundary.

9. The material of claim 8, wherein said polygonal shape is one of a rectangle and a square.

10. The material of claim 8, wherein said material has a margin adjacent each side of said polygonal shape, each of said margins being defined between said outer boundary and a cut line of said indicia;
wherein opposite margins of said material are equivalent.

11. The material of claim 7, wherein said carrier layer is one of a paper release sheet and a polyester film.

12. The material of claim 7, wherein said applicable layer includes one of a heat transferable fabric and a thermoplastic.

13. The material of claim 7, wherein each of said indicia is chosen from a group of letters, numbers, and graphics.
